(19) United States
(12) Patent Application Publication
(10) Pub. No.: US 2015/0095052 A1
(43) Pub. Date: Apr. 2, 2015

(54) METHODS AND SYSTEMS FOR FACILITATING FINANCIAL SUBSIDIES OF PATIENTS' PRESCRIPTION MEDICATION COSTS IN CONJUNCTION WITH MEDICATION SYNCHRONIZATION SERVICES

(71) Applicant: David Roey Weinstein, Danville, CA (US)

(72) Inventor: David Roey Weinstein, Danville, CA (US)

(21) Appl. No.: 14/474,346

(22) Filed: Sep. 2, 2014

Related U.S. Application Data
(60) Provisional application No. 61/884,827, filed on Sep. 30, 2013.

(51) Int. Cl. G06Q 30/04; G06F 19/00

(52) U.S. Cl. CPC G06Q 30/04; G06F 19/328; G06Q 40/08
USPC 705/2

(57) ABSTRACT

In an embodiment of the invention, a computer implemented method and system maps and organizes information derived from a patients' medication regimens with information derived from a set of copay subsidy processors to facilitate financial subsidizations for patients participating in a synchronization service of their prescription medication fills.

### CROSS REFERENCE TO RELATED APPLICATIONS

This application claims priority to U.S. provisional patent application Ser. No. 61/884,827, filed Sep. 30, 2013, which application is incorporated herein in its entirety by this reference thereto.

### BACKGROUND OF THE INVENTION

1. Technical Field

The invention relates to the synchronization and subsidization of patients' prescription medication costs. More particularly, the invention relates to computer implemented methods and systems for mapping copayment subsidy billing codes to a set of prescription medications of patients who are being offered a medication synchronization service and applying computer implemented steps based upon said medication synchronization service to make available a set of subsidy billing codes that facilitate certain economic incentives through financial subsidies for these patients to participate in said medication synchronization services.

2. Background and Business Problem

Generally defined, medication adherence is the manner by which a patient complies with prescribed dosing regimens of his medications. Consider a patient who has been prescribed one medication to lower his cholesterol and a second medication to lower his blood pressure. Each medication is to be taken daily and the patient fills a 30 day supply of each medication. Good adherence to this regimen means that the patient takes the medication as prescribed and, every 30 days, picks up a prescription refill at the pharmacy so he does not find himself without medication at the time of next scheduled dosing. Poor adherence in this case might mean the patient forgets to take the medication every day or forgets to pick up his medication refill on time or deliberately is not adherent because the cost to the patient of the medications is too high. Poor adherence to medication therapy is often cited in research and studies as a significant contributing factor to the staggering cost of health care in the United States. As a very simple example, if a patient with high blood pressure is given a prescription for medication that lowers his blood pressure when taken as prescribed and that patient does not take his medication as prescribed, the likelihood that he would develop undesired medical events, such as a stroke, are higher than if he took his medication as prescribed.

There are many factors that contribute to poor adherence. One factor is the patient's out of pocket cost. Studies have shown that all things being equal, patients are less adherent if their out of pocket costs (sometimes known as “patient out of pocket costs” or “co-payments” or “co-pays”) are higher rather than lower, ceteris paribus. This inverse relationship between the monetary value of the co-pays and adherence has been widely accepted and publicized for years.

A second well understood and accepted cause of poor adherence is forgetfulness. Some patients forget to pick up their medications from their pharmacies before they run out of current supplies. Some patients forget to take their medications every day as prescribed.

More recently, a new factor contributing to poor adherence has been identified in patients whose regimens include two or more medications: asynchronous medication refill dates. Simply put, patients with asynchronous medication refill dates has some or all of the multiple medications in his regimen due for refilling at different days of the month. As a consequence, these patients must make multiple trips to their local pharmacies each month to pick up their medication refills on time and to remain adherent. Many of these patients do not pick up all these medication refills on time and as a consequence have poor adherence.

It is notable that the root causes of poor adherence attributed to asynchronous medication refill dates are actually driven in large part by patient out of pocket costs and forgetfulness:
When one is required to make more trips to a pharmacy each month as opposed to fewer trips, the cost to the patient in terms of time and money (e.g. gasoline or bus fare) are higher and the likelihood of “intended” poor adherence is greater;
When one is required to make more trips to a pharmacy each month as opposed to fewer, the likelihood of forgetting to pick up each medication on time is increased and the likelihood of “unintended” poor adherence is greater.

A typical medication synchronization program may work as follows:
1. A pharmacist is either (i) notified by a computer system or (ii) proactively identifies a patient as a medication synchronization candidate.
2. The pharmacist sets up an appointment for the patient to come into the pharmacy for a synchronization session; the session is typically scheduled when feasible to coincide with the regularly scheduled filling of a refill for one or more “anchor medications”. An anchor medication is designated as such because it will be filled with a normal days supply at the time of medication synchronization and some or all of the other medications in the patient's regimen will be filled with abnormal days supplies so that in subsequent months, most if not all of the patient's prescription refills are due on the same day of the month.
3. When the patient arrives and agrees to the medication synchronization service, the pharmacist fills the non anchor medications with abnormal days supplies (also known as “partial refills” or “short fills”) so that each of them will have a go forward refill due date that coincides with the refill due date of the anchor medication(s).
4. The patient pays the pharmacist the co-payment on each medication as calculated by his pharmacy benefit.

While medication synchronization programs provide patients with the benefit of reducing the number of pharmacy trips in a given month, they also operate under a set of rules that create a perverse incentive for patients. Specifically, patients are sometimes financially motivated NOT to accept an offer of synchronization. This incentive is created by the fact that pharmacy benefits are generally structured as a fixed co-pay for a 30 or 90 day supply or as co-insurance factor a floor and cap on patient co-pays also based on a 30 or 90 day supply. However, if a patient is dispensed a quantity less than 30 days supply, his co-pay is nonetheless usually based upon a 30 days supply. Therefore, there is an economic disincentive created by the current system for patients to synchronize their prescription refills because synchronization generally requires that one or more prescription medication fills are “short filled”, filled with a below normal quantity and the patient is paying more than usual per days supply. The consequence, of course, is lower adoption of medication synchronization in the population and poorer adherence.

In essence, there is a fundamental challenge that must be solved for medication synchronization programs to achieve better adoption by patients:

### Patient Co-Pays for Medication Refills With Abnormal Days Supplies Generally Required for Synchronization Often Represent an Increase in Patient Cost Per Days Supply of the Medication Refills

The following example illustrates this challenge:

In order to synchronize a patient's medications, a pharmacy will typically designate one or more of the medications to be synchronized as “anchor meds”. An anchor meds is typically filled with a normal quantity. Assume an anchor med, Medication A, is due to be filled on the 15th of the month. The pharmacy will fill Medication A on the 15th of the month. But a pharmacy staff person will notify the patient ahead of the 15th and offer to sync up the patient's others meds by dispensing short fills of the other medications on the 15th.

Let's assume the patient has two other chronic meds, Medication B and Medication C. All three meds are typically dispensed as 30 day supplies. Now, assume further that Medication B is due to be refilled on the 20th of the month and Medication C is due to be refilled on the 1st day of the next month.

| | | Last Fill Days | Next Regular |
|---|---|---|---|
| Medication | Last Fill Date | Supply | Refill Due Date |
| Medication A | March 16 | 30 | April 15 |
| Medication B | March 21 | 30 | April 20 |
| Medication C | April 1 | 30 | May 1 |

In order to sync up the patient's meds, the pharmacy will dispense the following days' supply of the three meds.

| Medication | Days Supply |
|---|---|
| Medication A | 30 |
| Medication B | 25 |
| Medication C | 15 |

Now, for the sake of simplicity, assume that the cost structure of each medication is identical; they all have selling prices of $70 for a 30 day supply. Further assume that the patient's copay for each medication is $30 for a 30 day supply under his pharmacy benefit.

On med-sync day, which in this illustration is the 15th of the month, the following actions occur:

Medication A is filled as usual, the payer approves the claim and the patient pays $30.

Medication B is being filled 5 days early, close enough for the payer to approve the claim. The claim is approved and the patient's copay is also $30 since 30 day pricing is typical for days supply of 34 days or fewer.

Medication C's claim is rejected by the payer because it is being filled too soon. The pharmacy refills a 15 day supply and since the claim is not paid by the insurer, charges the patient the typical selling price which is $35 (selling price for a month's supply* 50%)+a $5 dispensing fee (for the half month) for a total of $40. Thus, we have the patient facing the following prices:

| | Co-Pay | Co-Pay | Price/Daily | Price/Daily |
|---|---|---|---|---|
| | with Med | without Med | Supply with | Supply without |
| Medication | Sync | Sync | Med Sync | Med Sync |
| Medication A | $30 | $30 | $1.00 | $1.00 |
| Medication B | $30 | $30 | $1.20 | $1.00 |
| Medication C | $40 | $30 | $2.67 | $1.00 |
| Total | $100 | $90 | | |

Thus, the patient is being asked to pay a higher cost per days supply on Medications B and C and faces a higher out of pocket cost for “fewer pills” in the case of Medication C. An August 2012 study by AccentHealth showed that 35% of patients would switch pharmacies to save $5 or less in copays. Thus, it is reasonable to infer that many patients will similarly balk at paying either or both of [i] higher out of pocket costs or [ii] higher per daily supply costs.

It is useful to note that even if only a subset (i.e., not all) of the medications being synchronized had subsidies facilitated, the invention to be described would improve the patient's financial incentives to synchronize.

Related Challenge: Pharmacy Workflow is Not Conducive to Setting Appointments

Traditional retail pharmacies are transaction centric, not appointment centric. It is notable that many so called medication therapy management programs at retail pharmacies have failed in part because they required pharmacies to set appointments and allocate staff time for these spikes in work demands. Retail pharmacy staff people found that they were not able to adjust to this alternative workflow/scheduling model in a cost effective manner. The current medication synchronization programs seem to require that a lot of preparation be done, a “sync” appointment to be set in advance and agreed upon with the patient and that the patient come into the pharmacy on or around the date and time of the sync appointment to make it work. It is often the case that there are deviations from what is planned to what actually occurs whether it is the patient missing an appointment or the pharmacy staff not being staffed sufficiently when the patient arrives.

Therefore, there is a great need in the field of health care for a cost effective, efficient, method to synchronize patients' chronic medication refill dates that aligns financial incentives for the patients to participate in a medication synchronization service. An enhancement of the method to incenting the patient to participate in a medication synchronization service would be to facilitate a process that does not require that the pharmacy staff to make a special “synchronization appointment” with the patient. Certain embodiments of the invention facilitate this enhancement.

### Description of Background Services

Background services are generally found in two areas: (1) medication fill synchronization programs and (2) prescription co-payment subsidy programs. Both areas of background services purport to have some element of “increased patient adherence to medication regimens” as their value propositions.

### Medication Fill Synchronization

In recent years, services have come to market that portend to have as their goal the synchronization of prescription medication refills. The synchronization of prescription medication refills for patients whose medication regimens include two or more chronic medications (sometimes referred to as “synchronization” or “medication synchronization” or “med-sync”) is the process by which the due dates for the refills of two or more prescription medications are manipulated to fall on the same calendar day beginning with the subsequent month (i.e., on a go forward basis) through the dispensing this month of abnormal days supply quantities for at least one of them.

Synchronization has benefits to many stakeholders in the health care system. Patients spend less time each month traveling to and from their pharmacies. Since they are likely to be more adherent to all their medication regimens when prescription refill due dates fall on the same day each month, these patients will have better health outcomes. When patients are more adherent, pharmacies, pharmaceutical wholesalers and pharmaceutical manufacturers benefit from increased prescription sales. Health plans and other entities at risk for health outcomes benefit because patients adherent to prescribed medication regimens are likely to have lower medical/hospital costs than non-adherent patients, ceteris paribus.

There are synchronization programs in the market today. A non limiting illustration of how a synchronization program might work is as follows: A pharmacist looks up information about a patient on a computer system. She qualifies the patient as being “synchronization-eligible”. She also identifies an “anchor medication”, the medication which will be filled with normal quantities as part of the synchronization process. Next, she calls the patient and makes an appointment for the patient to come to the pharmacy to have all of his chronic medications synchronized.

When the patient arrives at the pharmacy, he is given a normal (typically a one month's supply) quantity of the anchor medication(s) and abnormal quantities of the non anchor medication(s). The actual quantities dispensed for the non anchor medications are calculated so that on a go forward basis, all the patient's chronic medications will be due for refill on the same day of the month.

As one example, Ateb Inc. supports a synchronization program called “Time My Meds™” which generally follows the preceding description.

### Prescription Co-Payment Subsidies for Patients at the Point of Sale

It has been demonstrated that patient prescription co-pays can be a barrier to prescription medication adherence. Patients may decide that they either cannot afford the out of pocket expense of the medication (either with or without an insurance subsidy toward the cost of the medication) or that the medication is just “not worth it”. Thus, some patients stop taking their chronic medications prematurely relative to prescriber instructions or they cut back on their daily dosing to make the “pills last longer”. The most extreme form of non-adherence is sometimes called “Abandonment”. Abandonment is a term used in the industry to refer to a patient who asks that a new prescription be filled, but when informed by pharmacy staff of his out of pocket co-pay, the patient refuses to make the purchase and thus never begins the regimen prescribed.

Co-payment subsidy programs have developed over the years to try and mitigate the financial drivers of poor adherence and abandonment.

Although co-payment (or “co-pay”) subsidy programs vary as to the medications covered and the specific dollar amount of the subsidies, these programs generally work the same way. Individuals enroll in medication specific subsidy programs online and the sponsor mails them wallet-size copay subsidy cards that contain information for pharmacists to submit subsidy requests or health care providers hand patients medication specific co-pay subsidy cards that have been supplied by copay subsidy program sponsors or the patients print the co-pay subsidy cards directly from a website. Some programs require patient enrollment in which the patient provides basic information (name, address, and whether they have private health insurance coverage). Other programs do not. In all cases, however, these cards or printouts have a set of codes that when conveyed to pharmacy staff person, allow a subsidy request to be submitted by pharmacy staff to one or more copay subsidy processors. In some cases, the subsidy request is submitted once the patient's primary insurance has been billed and returns to the pharmacy's system the dollar value of the patient's co-pay. In other cases, this subsidy request is filed as a primary request; the patient's insurance, if any, is not billed. So, patients present their copay subsidy cards at the pharmacy, and the pharmacy staff processes the prescription using the information on the cards. The pharmacy staff typically enters information into a computerized pharmacy management system in order to submit a subsidy request. The subsidy request is sent to a co-pay subsidy processor which pays the pharmacy the amount of the subsidy and is in turn reimbursed by the program sponsor, usually a medication manufacturer. In this manner, the mechanics of a co-pay subsidy are quite similar to the billing of an insurer.

A cottage industry exists today to provide these co-pay subsidy processing services. Providers of these types of services include McKesson Corporation, Pharmacy Data Management, Inc. and TrialCard Inc.

In addition, a similar but more nuanced co-pay subsidy processing service is supported by RelayHealth Corporation, a subsidiary of McKesson Corporation. RelayHealth has a service called “eVoucherRx™”. With eVoucherRx, the patient is not required to present any subsidy billing codes to the pharmacist. RelayHealth is a claims clearinghouse between pharmacies and insurers. For a medication participating in the eVoucherRx program, RelayHealth intercepts the paid pharmacy claim on the way back from the patient's insurer to the pharmacy and adds an extra “subsidy” to the patient's co-pay when it reports the patient's out of pocket cost back to the pharmacy. Often times, patients receiving an eVoucherRx subsidy are unaware that a subsidy has even been provided. Nevertheless, eVoucherRx is quite similar to all the other co-pay subsidy services: A co-pay subsidy processor adds a subsidy to the patient's co-pay, then is reimbursed by the program sponsor, often the medication's manufacturer.

These co-pay subsidy programs are typically applied to a “normal” days supply of medication and always without being informed by a coincidental medication synchronization service. In other words, these programs and their business rules are typically ignorant of any other medications being filled coincidentally for a specific patient.

In the market, there does not exist today a method and system to facilitate financial subsidies of patients' costs of prescription medications in conjunction with medication synchronizations services (i.e. of at least two prescription medications) by providing pharmacy staff a method to request and receive sets of subsidy billing codes to enable requests for said financial subsidies wherein said subsidies will increase patients' incentives to participate in said medication synchronizations services.

### BRIEF SUMMARY OF THE INVENTION

In brief summary, the invention provides methods and systems that allow sponsors of financial subsidies of patients' medication prescription costs when said medications are part of a medication synchronization service to store sets of subsidy billing codes and subsidy program business rules for certain medications. The invention provides methods and systems for pharmacy staff persons to request said subsidy billing codes by submitting subsidy billing code request which are compared with subsidy program medications and subsidy program business rules and, if the programs' logics permit, return subsidy business codes to said pharmacy staff persons for use in making subsidy requests to subsidy program sponsors or their argents or processors.

In some embodiments, the invention comprises computer implemented methods to merge information from a medication synchronization service with a co-payment subsidy program to create a Subsidized Medication Synchronization Notice.

In some embodiments, the invention resides in a system that communicates with a computerized pharmacy management system or resides within a computerized pharmacy management system.

In some embodiments, the invention resides in a system that communicates with a copay subsidy processor computer system or resides within a copay subsidy processor's computer system.

In some embodiments, the invention comprises computer implemented methods and systems to store subsidy billing codes that will be used to generate necessary information that allow pharmacy staff or pharmacy computer systems to submit requests for patient co-payment subsidies for one or more target meds that are eligible for a copayment subsidy (“eligible meds”).

In some embodiments, these subsidy billing codes include computer generated, subsidy identifiers that are drawn from a pool of pre-approved subsidy identifiers derived from one or more participating co-payment subsidy processors.

In some embodiments, these subsidy billing codes include a computer generated processor control number (PCN).

In some embodiments, these subsidy billing codes include a computer generated bank identification number (BIN).

In some embodiments, these subsidy billing codes include a computer generated group number (Group).

In some embodiments, the Subsidized Medication Synchronization Notice includes a medication identifier such as a National Drug Code (NDC) and subsidy billing codes for each eligible med.

In some embodiments, the invention makes the subsidy billing codes in the Subsidized Medication Synchronization Notice available to pharmacy staff.

In some embodiments, the invention conveys the Subsidized Medication Synchronization Notice to the pharmacy staff via facsimile, electronic message (email), SMS message, or web services.

In some embodiments, the invention conveys the Subsidized Medication Synchronization Notice to the pharmacy staff by sending data to the pharmacy's computerized management system.

In some embodiments, the invention conveys the Subsidized Medication Synchronization Notice to the pharmacy staff by sending a message that is printed on a printer and accessible to pharmacy staff.

In some embodiments, the pharmacy staff uses these subsidy billing codes to submit subsidy requests to one or more co-pay subsidy processors that adjudicate these subsidy requests and, upon successful adjudication, return messages to the pharmacy's computer system that create a credit or credits against the patient's co-pays for one or more of the medications being synchronized.

In some embodiments, the invention uses the identifier of one of the medications being synchronized to inform the business rules regarding whether one or more of the other medications being synchronized are eligible for subsidies.

### BRIEF DESCRIPTION OF THE DRAWINGS

FIG. 1 is a schematic diagram that illustrates a non-limiting example of how the invention receives and stores Subsidy IDs (sometimes also referred to as “Member IDs”), Group and BIN and PCN data and medication identifiers of subsidy eligible medications and program business rules from co-pay subsidy processors and stores them in a computer for use in conjunction with medication synchronization subsidization processes.

FIG. 2 is a schematic diagram that illustrates a non-limiting example of how the invention receives a request for subsidy billing codes from a pharmacy management system in conjunction with medication synchronization subsidization processes.

FIG. 3 is a schematic diagram that illustrates a non-limiting example of how the invention compares the medication identifiers of the target meds in the requests for subsidizations with the identifiers of subsidy eligible medications to determine if the requests for subsidy billing codes should be rejected or proceed.

FIG. 4 is a schematic diagram that illustrates a non-limiting example of how the invention proceeds to apply the requests for subsidy billing codes to subsidy business rules, if any, and, if the business rules permit, generates a set of subsidy billing codes for target medications and makes them available to pharmacy staff.

FIG. 5 illustrates a non-limiting example of some of the information that the subsidized medication synchronization opportunity notification might contain.

FIG. 6 is a schematic diagram that illustrates non-limiting examples of how the invention might make the subsidy billing codes available to the pharmacy staff.

FIG. 7 is a schematic diagram that illustrates a non-limiting example of how the pharmacy staff uses the subsidy billing codes made available by the invention to request and obtain co-payment subsides for the patient participating in medication synchronization.

FIG. 8 is a block schematic diagram that depicts a machine in the exemplary form of a computer system within which a set of instructions exists for causing the machine to perform any of the herein disclosed methodologies and processes.

FIG. 9 is a system diagram that depicts a computer with the application containing instructions that support performing the actions described herein running thereon, a database connected to said computer, a pharmacy computer, copay subsidy processor computer, fax machine, printer and a communications network.

FIG. 10 is an entity relationship diagram describing in a non limiting illustration the relationships of some of the tables that may be found in the database attached to the service computer.

FIG. 11-FIG. 14 depict non limiting examples of other tables that may be found in the database attached to the service computer to support the functions described herein.

FIGS. 15A and 15B illustrate a non limiting flow diagram for the process and business logic to provide subsidy business codes in accordance with an example embodiment of the invention.

### DETAILED DESCRIPTION OF THE INVENTION

Embodiments of the invention relate to the field of health care. More specifically, in some embodiments, the invention comprises computer implemented methods to map a medication synchronization service to one or more co-payment subsidy programs to make available subsidy billing codes to pharmacy staff to be used in conjunction with a medication synchronization service.

Embodiments of the invention comprise computer implemented methods and systems to receive a set of subsidy billing codes, including program specific Subsidy IDs and program business rules derived from copay subsidy processors, receive requests for copay subsidy billing codes for patient prescription medications subject to a medication synchronization service, perform analysis of the subsidy billing code requests, and make available subsidy billing codes containing information with which pharmacy staff may use to submit requests for copayment subsidies.

### Definitions

As used herein, the term “Subsidized Medication Synchronization Notice ” or “ Subsidy Synchronization Notice” means a set of data containing subsidy billing codes created in response to a subsidy billing code request.

As used herein, the term “eligible medication” or “eligible med” or “subsidy eligible medication” means a medication belonging to a set of medications whose refill dates are to be synchronized as part of a medication synchronization service and furthermore is eligible for a copay subsidy based upon the business rules established by or agreed upon by the sponsor of the copay subsidy program.

As used herein, the term “target med” or “target medication” means a medication whose identifier is contained within a request for subsidy billing codes.

As used herein, the term BIN means bank identification number. BIN is often used by copay subsidy processors as a routing guide for an electronic subsidy request sent to them via a clearinghouse.

As used herein, the term PCN means processor control number. The PCN may be an alphanumeric string which is sometimes used by copay subsidy processors for intra-BIN routing.

As used herein, the term Group or Group Number means group number which is often used by copay subsidy processors for intra-BIN routing as a proxy for a medication or a set of medications with similar subsidy business rules or similar subsidy sponsors or belonging to the same subsidy program.

As used herein, the term Subsidy ID or Member ID means a string of numbers or characters used by copayment subsidy processors to map a request for a copay subsidy for an target med to a specific set of subsidy billing codes for purposes that may include but not be limited to identifying duplicate subsidy requests.

As used herein, the term “subsidy billing codes” means a set of values that facilitate the processing of a request for a copayment subsidy or subsidies for one or more eligible meds and may include one or more of BIN, PCN, Group and Subsidy IDs.

As used herein the term “mapping” shall generally mean the process by which something, such as data, is taken from a state where it is ungrouped or unorganized or unassociated with other data and then grouped and organized and associated to other data, typically in a database which is stored in a digital medium such as a computer hard drive. One embodiment of mapping is the process of taking an identifier of an eligible med subject to a medication synchronization service and grouping this identifier with a pre-approved Subsidy ID drawn from a pool of pre-approved Subsidy IDs, BIN and perhaps other data to create a set of subsidy billing codes.

As used herein, the term “anchor med” shall mean a medication whose refill date is relatively coincidental with the date of the medication synchronization service. As such, an anchor med may not require a co-payment subsidy as part of the financial incentive alignment between the patient's out of pocket expenditures for the medications filled at the time of medication synchronization and the medication synchronization service. However, the identity of the anchor medication may inform subsidy business rules regarding whether other target medications in the medication synchronization service are eligible for subsidies.

As used herein, the term “eligible med” shall mean a medication for which a copay subsidy processor will pay a subsidy to the pharmacy for the dispensing of the medication in conjunction with a medication synchronization service.

As used herein, the term “non-eligible med” shall mean a medication for which a copay subsidy processor will not pay a subsidy to the pharmacy for the dispensing of the medication in conjunction with a medication synchronization service, subject to subsidy business rules, if any.

As used herein, the term “computer” generally refers to a machine, apparatus, or device that is capable of accepting and performing logic operations derived from software code.

The term “software,” “software code,” or “computer software” as used herein refers to any set of instructions operable to cause a computer to perform an operation. Software code may be operated on by a rules engine or processor. Thus, the methods and systems of the invention may be performed by a computer based on instructions received by computer software.

The term “pharmacy management system” as used herein is a type of computer or computer system used by pharmacy staff to manage and record pharmacy transactions and may be used to transmit subsidy requests to co-pay subsidy processors.

As used herein the term “data network” or “communications network” shall mean an infrastructure capable of connecting one or more computers, either using wires or wirelessly, allowing them to transmit and receive data. Non-limiting examples of data networks may include the Internet and intranets including, but not limited to, Wi-Fi networks or wireless cellular networks, e.g. 3G and 4G LTE. To the extent protected health information as defined by HIPAA is being transmitted, these networks may be capable of transmitting, routing, and receiving messages in a secure and/or encrypted manner.

As used herein, the term “database” is an organized collection of data. The data in a database are typically organized to model relevant aspects of reality, for example the organization of information about a patient's health, in a way that supports processes requiring this information. One example of a database is a digital collection of patient information, such as prescription medication records relating to a patient. For the purposes of the disclosure herein, a database may be stored on a server or other computer and accessed through a data network, e.g. the database is in the cloud, or alternatively in some embodiments the database may be stored on a directly accessible computer itself, i.e. local storage.

### Discussion

To solve the technical problem of improving a patient's financial incentive to participate in medication synchronization, a process by which medication synchronization is combined with copayment subsidies into a holistic schema is needed. The invention meets this need.

In some embodiments, the invention comprises computer implemented methods and systems to (i) receive a set of subsidy billing codes, including Subsidy IDs, and program business rules derived from copay subsidy processors and organize these data in one or more databases, (ii) receive requests for copay subsidy billing codes for target medications subject to a medication synchronization service, (iii) perform analysis of the subsidy billing code requests to determine if they meet the subsidy programs' business rules and (iv) make available a set of subsidy billing codes for use by pharmacy staff to support submission of subsidy requests to copay subsidy processors.

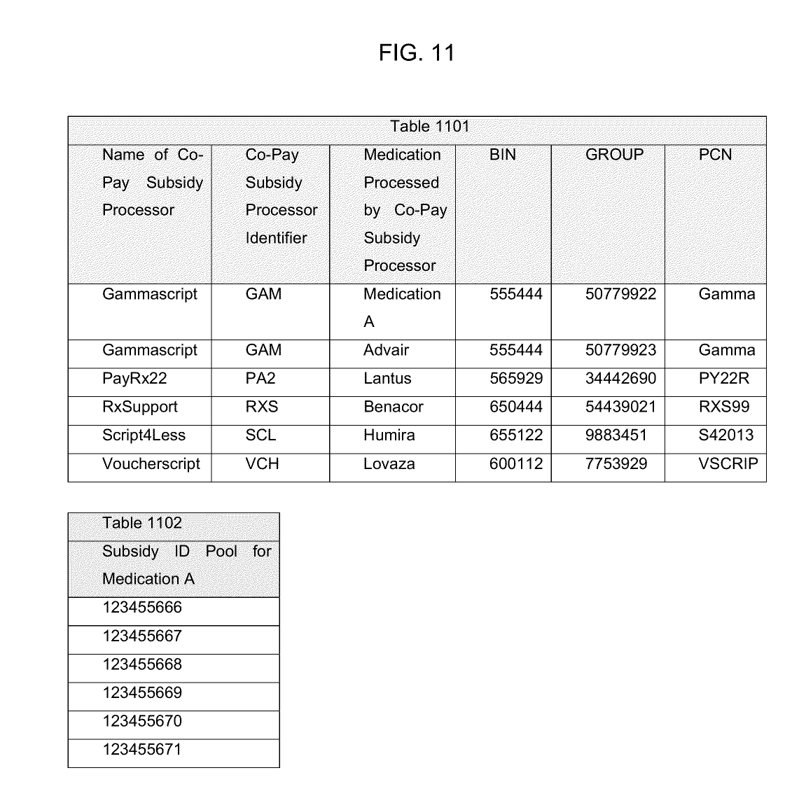

An embodiment of a mapping of eligible medications to certain elements of the subsidy billing codes may be, for example, a table of records that include medication identifiers and/or names and corresponding BIN, Group and PCN numbers. A non limiting example of such a table may be Table 1101 in FIG. 11.

An embodiment of a list of pre-approved program or medication specific Subsidy IDs to be sourced by the invention in creating a set of subsidy billing codes may be Table 1102 in FIG. 11.

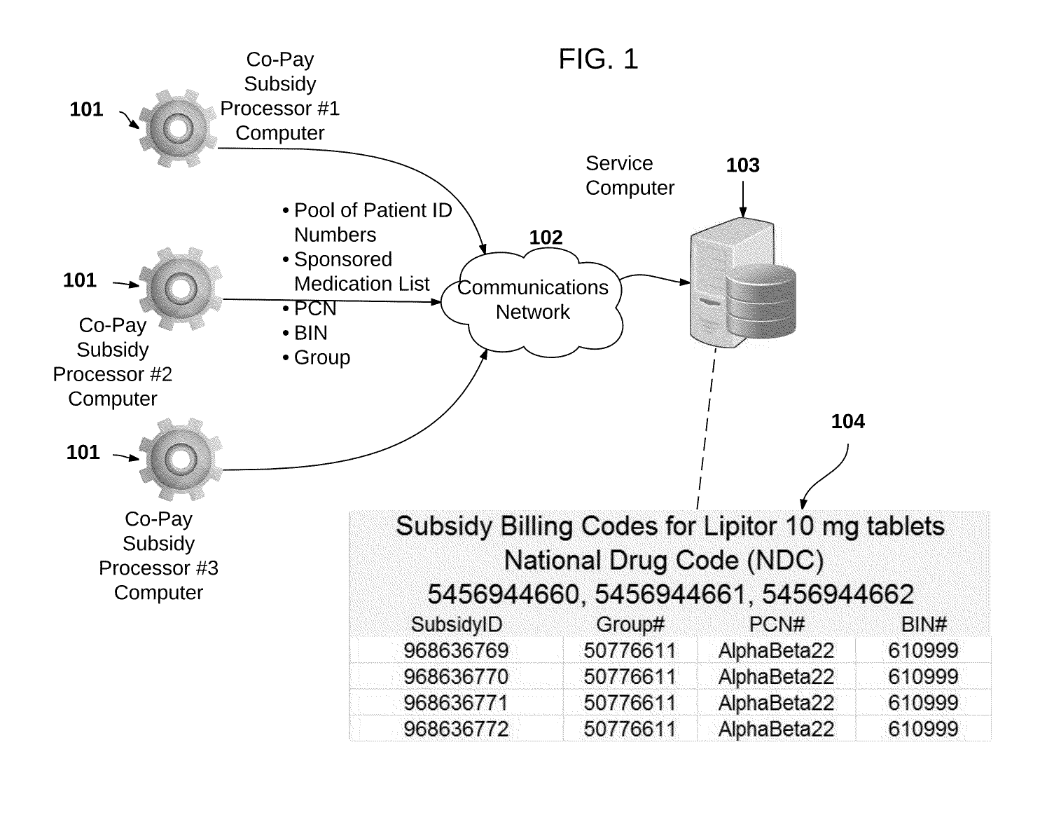

FIG. 1 is a schematic diagram that illustrates a non-limiting example of how the service computer running the application receives over a network 102 and stores Subsidy IDs (sometimes also referred to as “Member IDs”), Group and BIN and PCN data and identifiers of subsidy eligible medications from co-pay subsidy processors 101 and stores them in a table 104 in a computer 103 running an application using the invention in conjunction with creating subsidy billing codes for medications subject to a medication synchronization service.

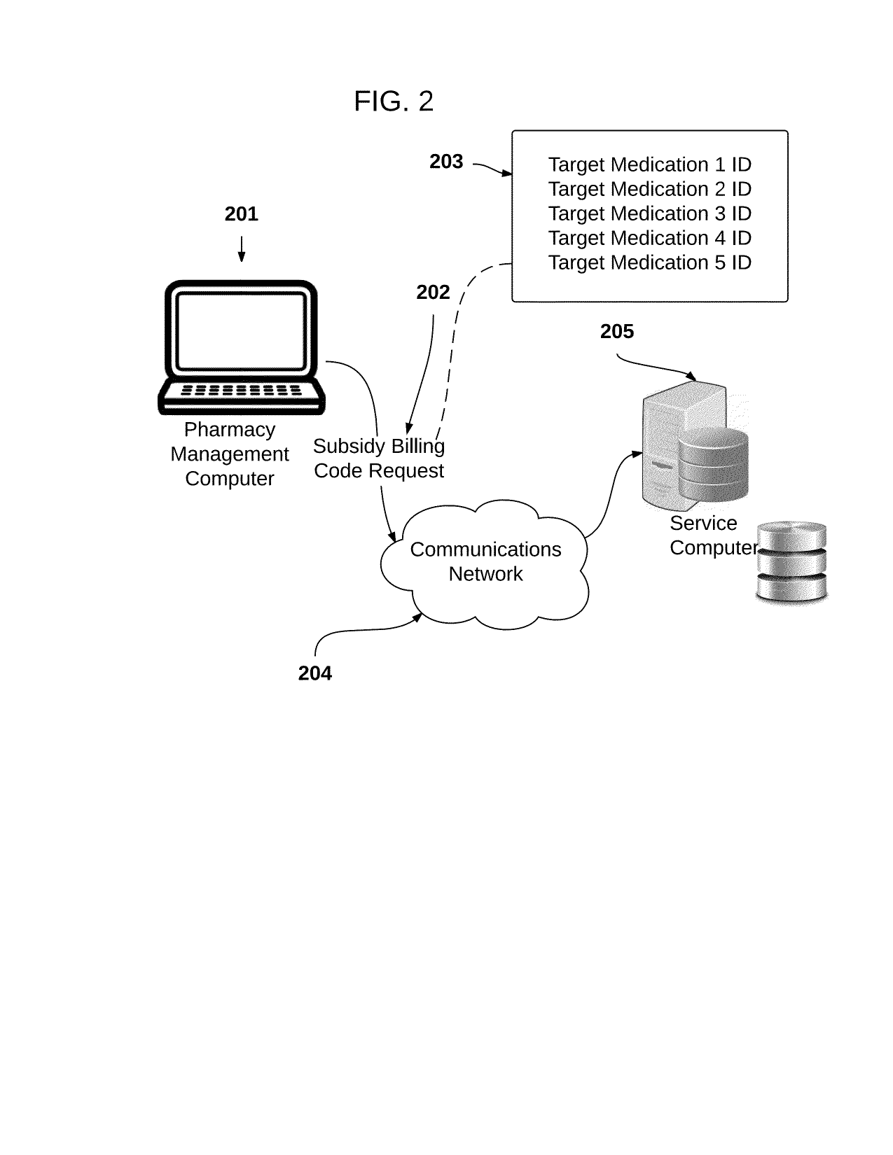

FIG. 2 is a schematic diagram that illustrates a non-limiting example of how the service computer 205 receives a request for subsidy billing codes 202 for target medications 203 via a communications network 204 from a pharmacy management computer 201 in conjunction with a medication synchronization service.

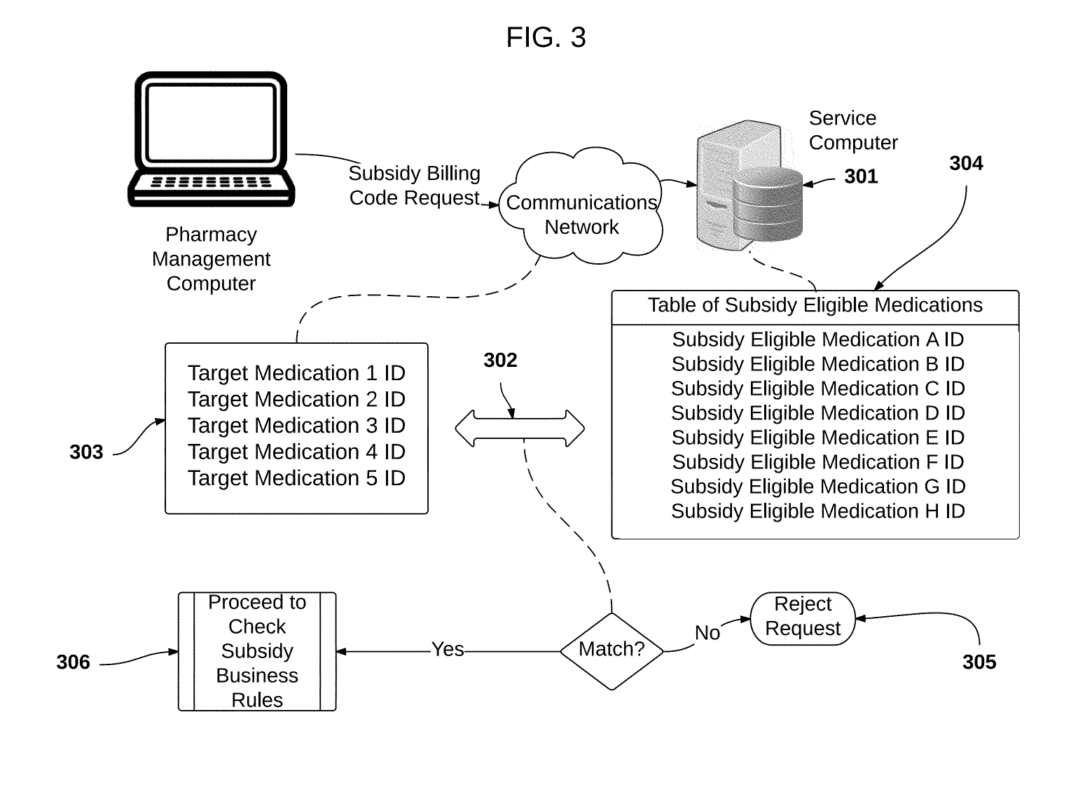

FIG. 3 is a schematic diagram that illustrates a non-limiting example of how the application running on the service computer 301 compares 302 the medication identifiers of the target medications in the requests for subsidy billing codes 303 with the identifiers of subsidy eligible medications 304 to determine if the requests for subsidy billing codes should be rejected if there are no matches 305 or proceed to be compared against certain subsidy business rules if there are matches 306.

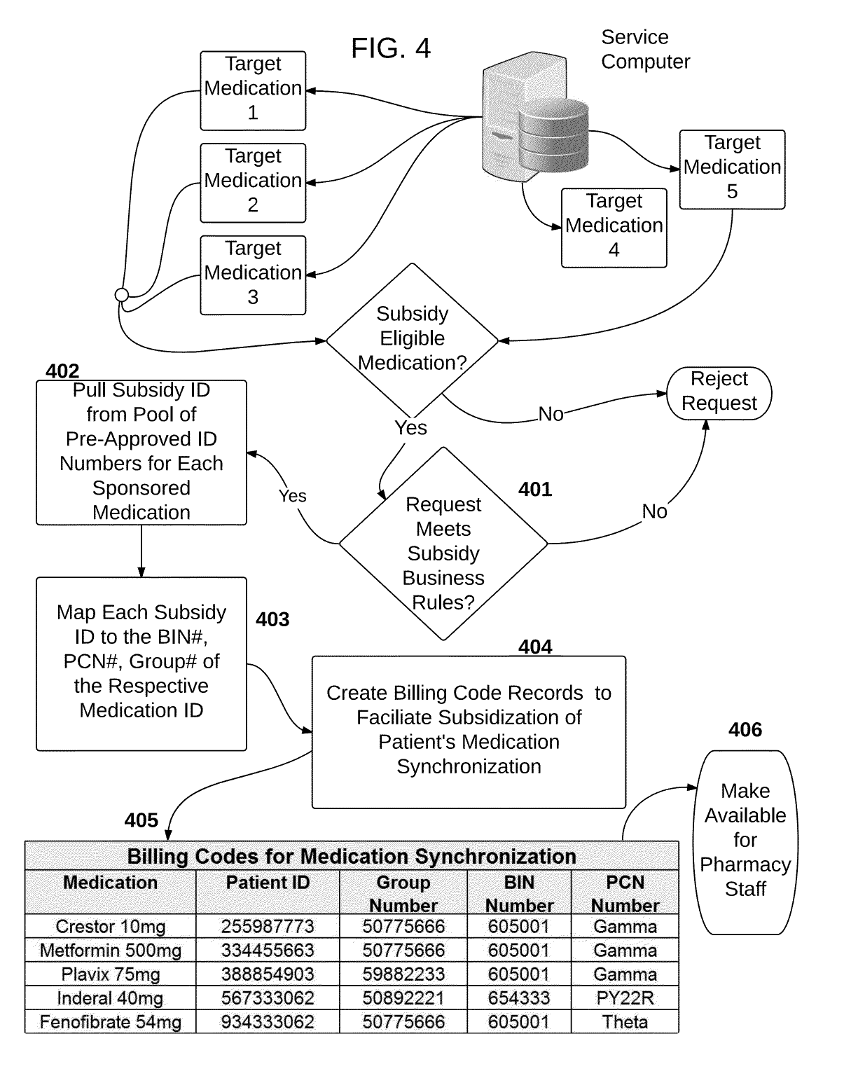

FIG. 4 is a schematic diagram that illustrates a non-limiting example of how the application proceeds to apply the requests for subsidy billing codes to certain subsidy business rules 401, if any, and, if the subsidy business rules permit, sources an unused Subsidy ID value 402 from the appropriate Subsidy ID table, sources the appropriate BIN, Group and PCN values for the eligible medications 403, generates a set of subsidy billing code records for one or more target medications 404 and writes them to a Subsidized Medication Synchronization Notice table 405.

In some embodiments, this process is repeated with all the target medications in the subsidy billing code request.

In some embodiments, if a target medication is a not an eligible med or does not meet subsidy business rules, then the values for BIN#, PCN#, Group# and Subsidy ID in the Subsidized Medication Synchronization Notice will be populated with values indicating it is a non eligible medication.

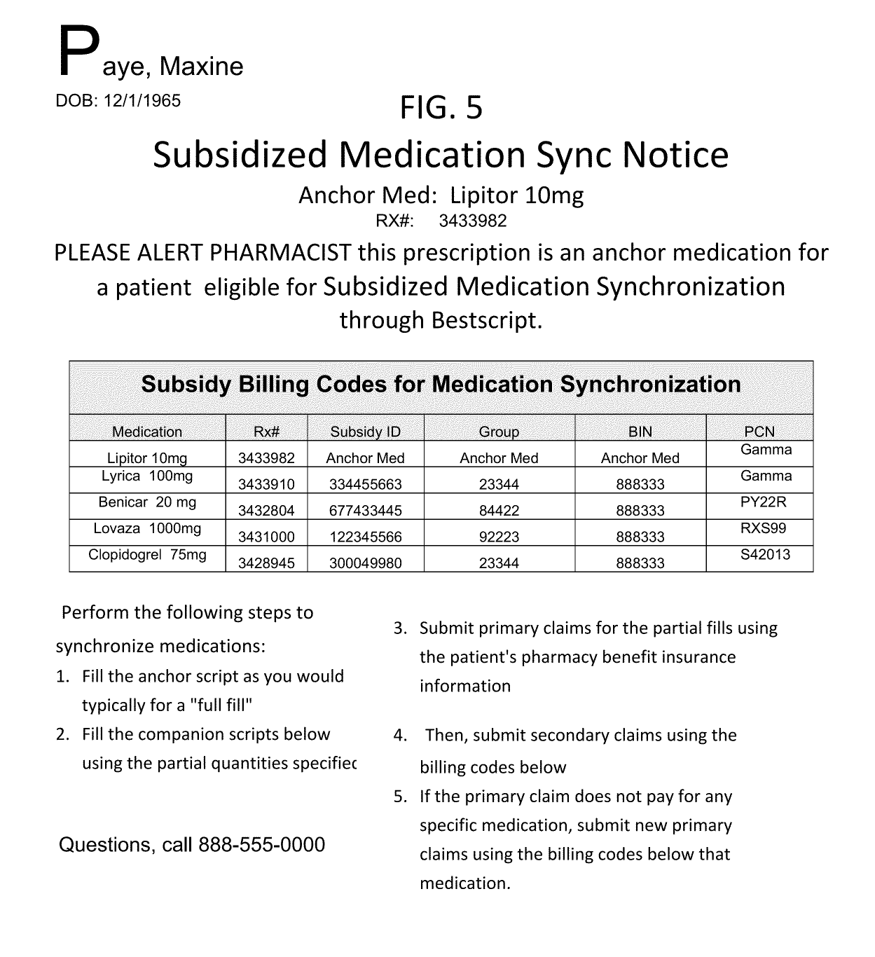

FIG. 5 is illustrates a non-limiting example of some of the information that the Subsidized Medication Synchronization Notice made available to pharmacy staff might contain. In connection with FIG. 5, the computer implemented methods and systems as described herein may be used in a non limiting fashion as follows:

The Subsidized Medication Synchronization Notice contains necessary information for the pharmacy staff to process a subsidy request for a prescription medication coincidental with a medication synchronization service. The Subsidized Medication Synchronization Notice may contain information including (i) eligible med identifiers, (ii) PCN, BIN and Group numbers for each of the eligible meds and (iii) Subsidy IDs for each of the eligible meds.

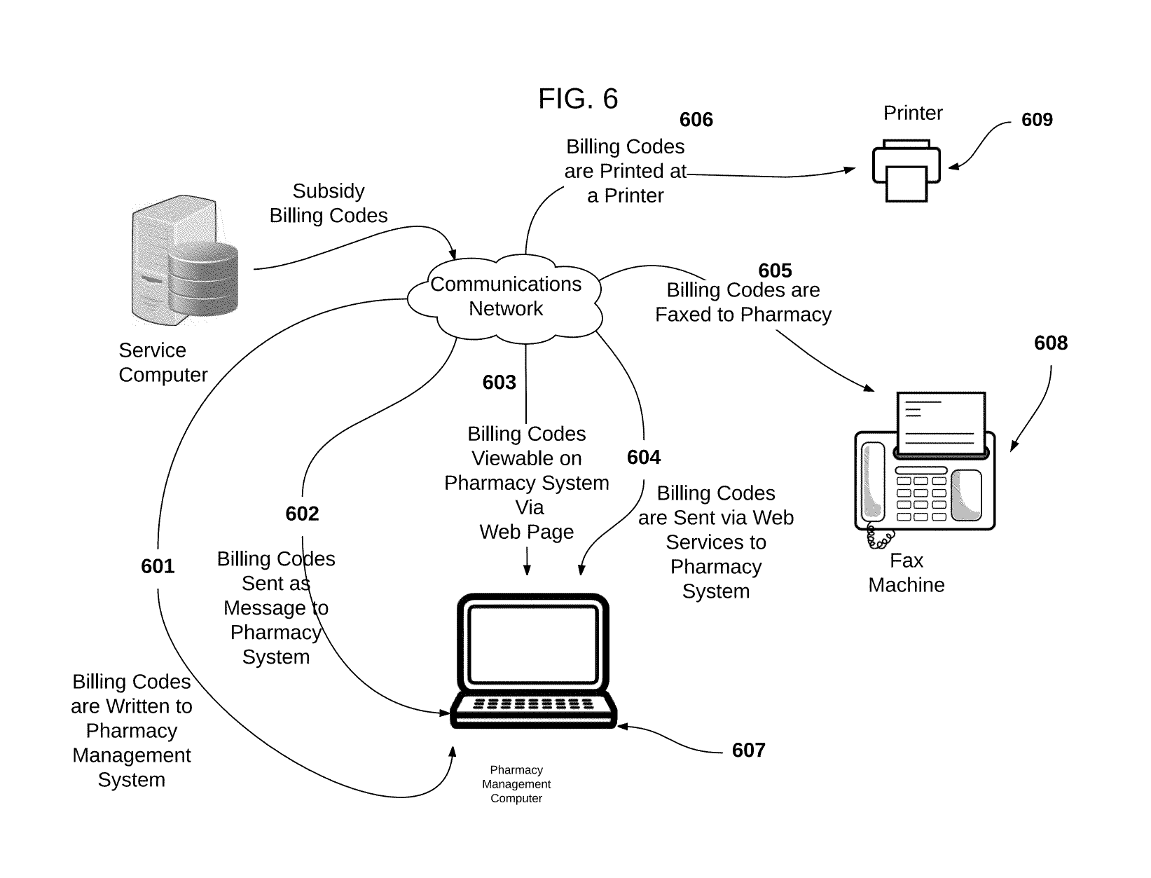

FIG. 6 is a schematic diagram that illustrates non-limiting examples of how the subsidy billing codes are made available to the pharmacy staff in human readable form or are written to the pharmacy management computer 607 where they may be used to automatically or manually submit claims for copayment subsidies in connection with a medication synchronization. In connection with FIG. 6, the computer implemented methods and systems as described herein may be used in a non limiting fashion as follows:

The data contained in the Subsidized Medication Synchronization Notice (i) are faxed 605 to the a fax machine at the pharmacy 608 and/or (ii) are printed 606 on a printer 609 accessible to pharmacy staff either automatically or in conjunction with a manual request and/or (iii) appear as message(s) 602 in the pharmacy management system 607 and/or (iv) are written 601 to the pharmacy management computer 607 and/or (v) are sent to the pharmacy management computer 607 via web services 604 and/or are viewable by pharmacy staff via a web browser 603 on the pharmacy computer 607.

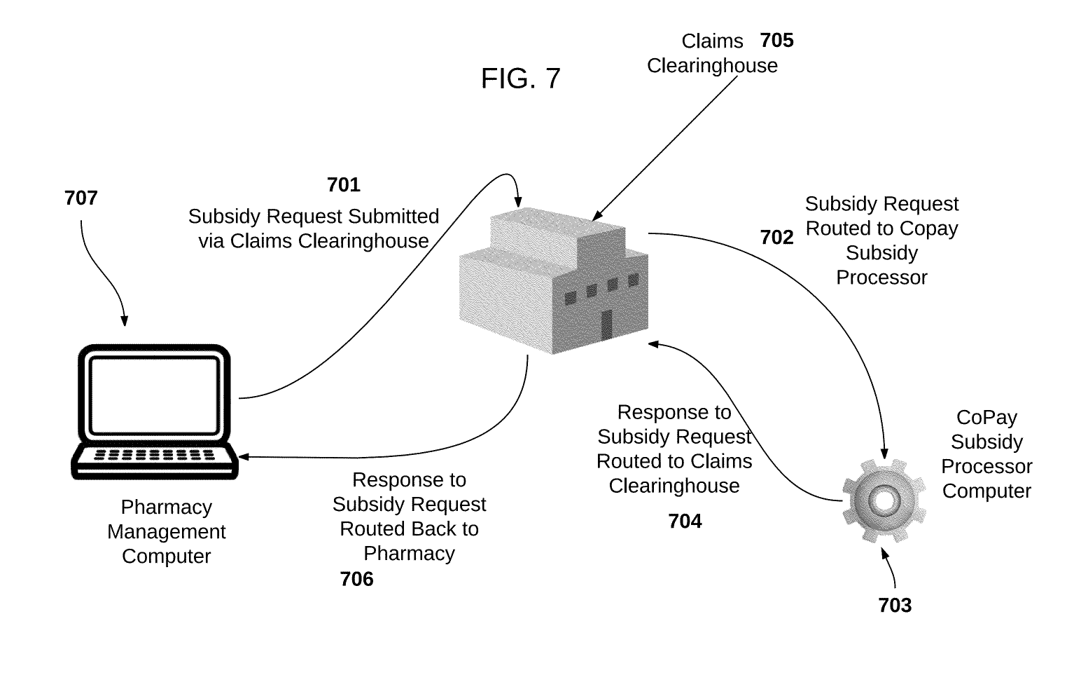

FIG. 7 is a schematic diagram that illustrates a non-limiting example of how the pharmacy uses the subsidy billing codes made available to the pharmacy staff to request and obtain co-payment subsides for the medications for a patient participating in medication synchronization.

Note that FIG. 7 shows only one way in which the output of the invention may be used. In connection with FIG. 7, the computer implemented methods and systems as described herein may be used in a non limiting fashion as follows:

The pharmacy staff person enters data which may include some or all of the subsidy billing codes for each eligible med and submits subsidy requests for the medications through his pharmacy system 701. Each subsidy request may travel via a clearing house 705 which routes the subsidy request 702 to the appropriate copay subsidy processor 703. The copay subsidy processor 703 adjudicates each subsidy request and, for each approved request, returns a response containing a receivable to the pharmacy which contains data that are used to reduce or eliminate the patient's copayment for each medication accordingly and for each rejected request, returns a response to the pharmacy indicating no subsidy. These responses 704 are routed back through a clearing house 705 which then routes the response back to the pharmacy.

### Computer Implementation

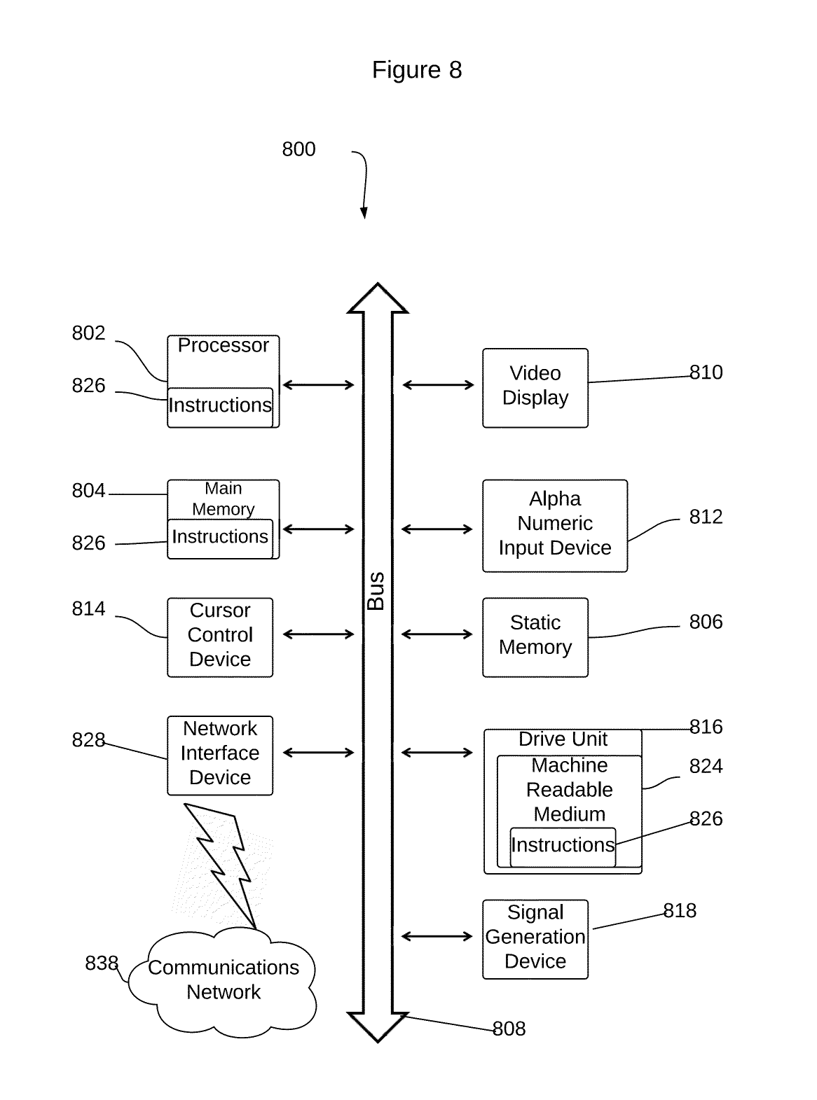

FIG. 8 is a non-limiting block schematic diagram that depicts a machine in the exemplary form of a computer system 800 within which a set of instructions for causing the machine to perform any of the herein disclosed methodologies and processes. In alternative embodiments, the machine may comprise or include a network router, a network switch, a network bridge, personal digital assistant (PDA), a cellular telephone, a smart phone, a computer tablet, a Web appliance or any machine capable of executing or transmitting a sequence of instructions that specify actions to be taken.

The computer system 800 includes a processor 802, a main memory 804 and a static memory 806, which communicate with each other via a bus 808. The computer system 800 may further include a display unit 810, for example, a liquid crystal display (LCD) or a cathode ray tube (CRT). The computer system 800 also includes an alphanumeric input device 812, for example, a keyboard; a cursor control device 814, for example, a mouse; a disk drive unit 816, a signal generation device 818, for example, a speaker, and a network interface device 828.

The disk drive unit 816, if included, includes a machine-readable medium 824 on which is stored a set of executable instructions, i.e. software, 826 embodying any one, or all, of the methodologies described herein below. The software 826 is also shown to reside, completely or at least partially, within the main memory 804 and/or within the processor 802. The software 826 may further be transmitted or received over a network 830 by means of a network interface device 828.

In contrast to the system 800 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

### System Overview

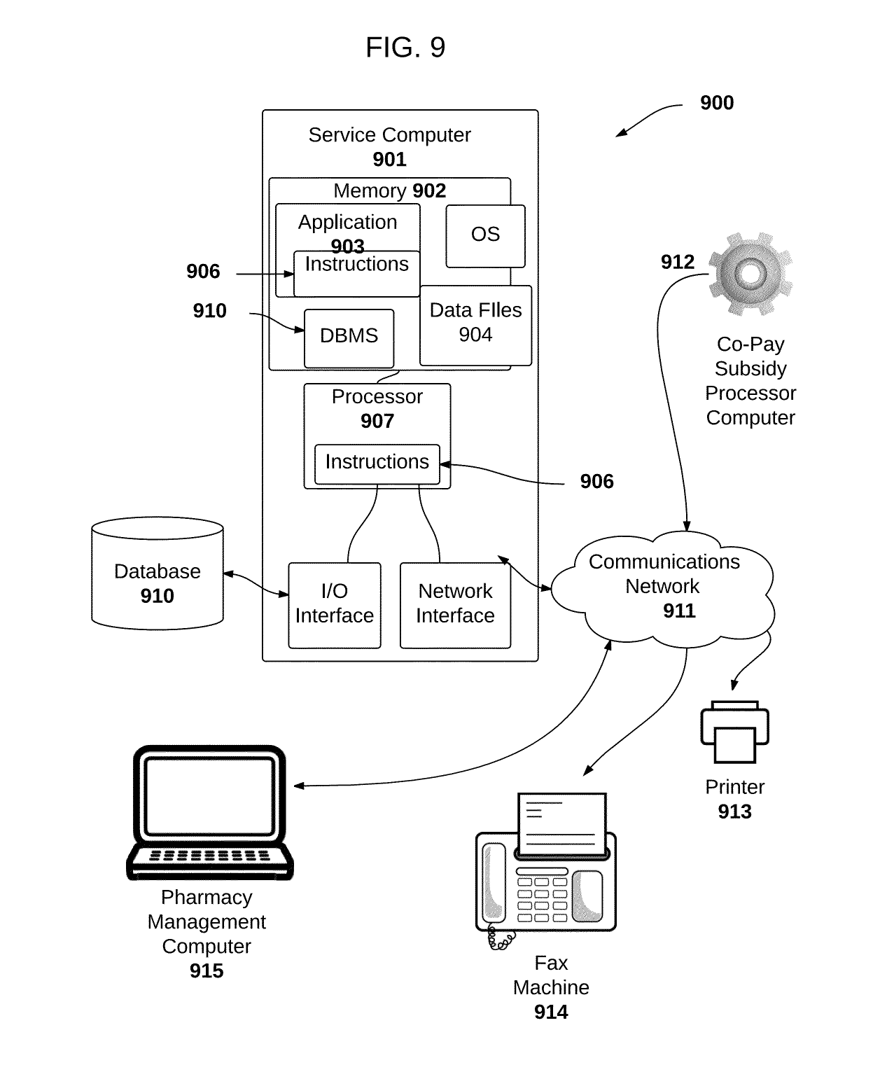

A non limiting example of a system 900 for supporting financial subsidization of patient out of pocket costs for prescription medications in conjunction with a medication synchronization service will now be described illustratively with respect to FIG. 9. As shown in FIG, 9, the system 900 may include a service computer 901 housing the application 903, a pharmacy management computer 915, and a copay subsidy processor computer 912, which are each configured for accessing and reading associated computer-readable media having stored thereon data and/or computer-executable instructions for implementing the various methods of the invention. Generally, network devices and systems, including the one or more service computers 901 one or more pharmacy management computers 915, and one or more copay subsidy processor computers 912 have hardware and/or software for transmitting and receiving data and/or computer-executable instructions over one or more communications links or networks. These network devices and systems may also include any number of processors for processing data and executing computer-executable instructions, as well as other internal and peripheral components that are well known in the art. By executing computer-executable instructions, each of the network devices may form a special purpose computer or particular machine. As used herein, the term “computer-readable medium” may describe any form of memory or memory device.

As shown in FIG. 9, the one or more service computers 901 housing the application 903, pharmacy management computers 915, and copay subsidy processor computers 912 may be in communication with each other via a communications network 911, which as described below can include one or more separate or shared private and public networks, including the Internet or a publicly switched telephone network. Each of these components—the one or more service computers 901 housing the application 903, pharmacy management computers 915, and copay subsidy processor computers 912—will now be discussed in further detail.

First, the copay subsidy processor computer 912 may be associated with one or more copay subsidy processors according to an example embodiment of the invention. The copay subsidy computer 912 may be any processor-driven device, such as a desktop computer, laptop computer, handheld computer, commercial server and the like. In addition to having processor(s), the pharmacy computer may further include memory, input/output (“I/O”) interface(s), and network interface(s). The memory may store data files and various program modules, such as an operating system (“OS”) and a client module. The memory may be any computer-readable medium, coupled to the processor, such as RAM, ROM, and/or a removable storage device for storing data files and a database management system (“DBMS”) to facilitate management of data files and other data stored in the memory and/or stored in separate databases. The OS may be, but is not limited to, Microsoft Windows®, Apple OSX™, Unix, Linux or a mainframe operating system. The copay subsidy processor computer, including a dedicated program, interacts with the service computer, 901, to provide the service computer 901, via a communications network, 909, the data elements and subsidy business rules associated with a copay subsidization program to be used in conjunction with medication synchronization. For example, the copay subsidy processor computer 912, may convey to the service computer, 901, via a communications network, 909, data elements including but not limited to BIN, Group, PCN and Subsidy IDs related to a particular copay subsidization program to be used in conjunction with medication synchronization. It will be appreciated that while the copay subsidy processor computer 912 has been illustrated as a single computer or processor, the copay subsidy processor computer 912 may be comprised of a group of computers or processors, according to an example embodiment of the invention.

Next, the pharmacy computer 915 may be associated with one or more pharmacies, including a retail pharmacy or pharmacy group, according to an example embodiment of the invention. The pharmacy computer 915 may be any processor-driven device, such as a desktop computer, laptop computer, handheld computer, commercial server and the like. In addition to having processor(s), the pharmacy computer may further include memory, input/output (“I/O”) interface(s), and network interface(s). The memory may store data files and various program modules, such as an operating system (“OS”) and a client module. The memory may be any computer-readable medium, coupled to the processor, such as RAM, ROM, and/or a removable storage device for storing data files and a database management system (“DBMS”) to facilitate management of data files and other data stored in the memory and/or stored in separate databases. The OS may be, but is not limited to, Microsoft Windows®, Apple OSX™, Unix, Linus or a mainframe operating system. The pharmacy management computer software, including a dedicated program, interacts with the service computer, 901, to provide the service computer 901, via a communications network, 909, subsidy billing code requests associated with a copay subsidization program to be used in conjunction with medication synchronization. For example, the pharmacy computer 915, may convey to the service computer, 901, via a communications network, 909, data elements including but not limited to identifiers of some or all of the target medications being synchronized for a particular patient, indicators as to whether any of the target medications are anchor medications, a pharmacy identifier and a transaction identifier. It will be appreciated that while the pharmacy computer 915 has been illustrated as a single computer or processor, the pharmacy computer 915 may be comprised of a group of computers or processors, according to an example embodiment of the invention. The service computer housing the application 901 includes, but is not limited to, any processor-driven device that is configured for receiving, processing, and fulfilling requests from a pharmacy management 915, relating to requests for subsidy billing codes or other activities. According to an example embodiment of the invention, the service computer 901 may comprise, but is not limited, to an application containing instructions to the process requests for subsidy billing codes and making said subsidy billing codes available to requestors through one or more embodiments including but not limited to (i) sending a message to the pharmacy computer 915, (ii) allowing them to be viewed via a web browser in the pharmacy computer 915, (iii) sending a facsimile to the requestor printed at a fax machine 914, and (iv) printing to a printer accessible by the requestor 913, all subject to copay subsidy business rules. The service computer 901 may include a processor 907, memory 902, input/output (“I/O”) interface(s) 908, and a network interface 909. The memory 902 may be any computer-readable medium, coupled to the processor 907, such as RAM, ROM, and/or a removable storage device for storing data files 904 and a database management system (“DBMS”) 910 to facilitate management of data files 904 and other data stored in the memory 902 and/or stored in one or more databases 910. The memory 902 may store data files 904 and various program modules, such as an operating system (“OS”) 905, a database management system (“DBMS”) 910, and the application 903. The OS 905 may be, but is not limited to, Microsoft Windows®, Apple OSX™, Unix, or a mainframe operating system. Instructions 906 to carry out the functions described herein may reside within the memory 902 and/or the application 903 and/or the processor 907.

The application module 903 may receive, process, and respond to subsidy billing requests from the pharmacy management computer 915 and may further receive, process, and respond to data from the copay subsidy processor computer 912. The database 910 may be one or more databases operable for storing information including but not limited to data elements comprising billing codes and subsidy business rules.

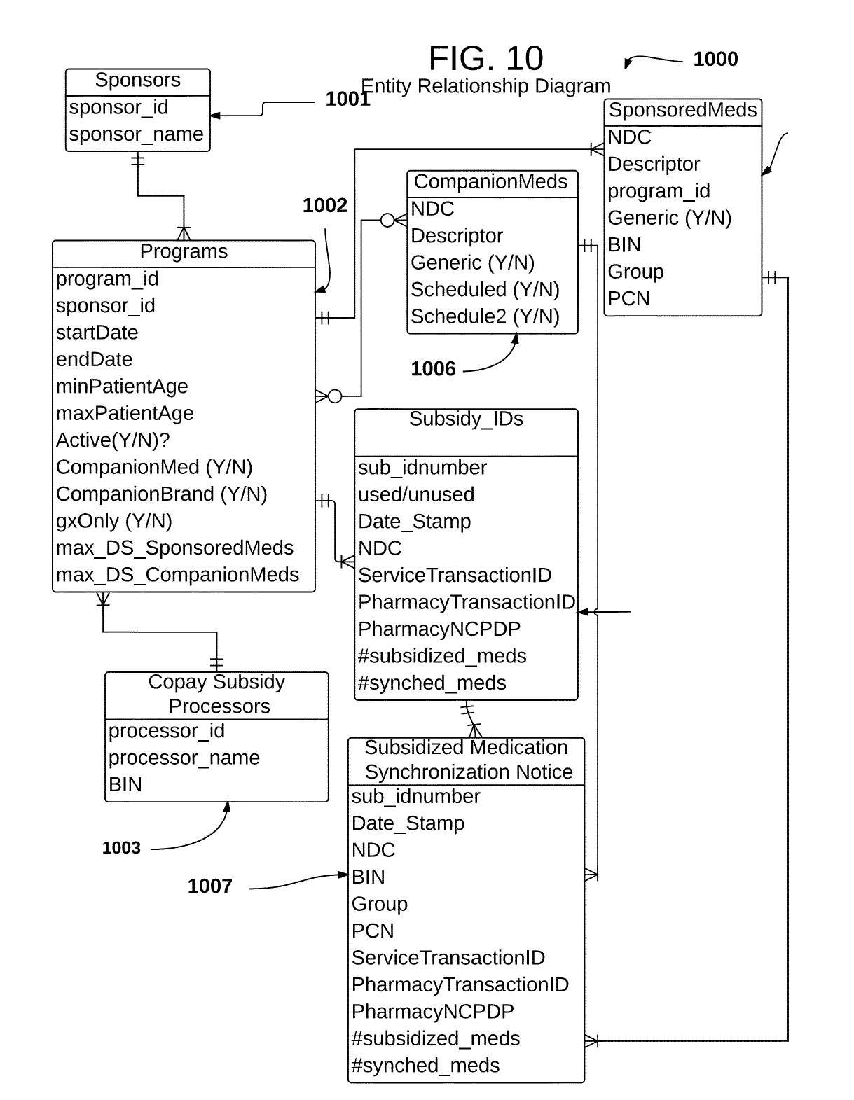

FIG. 10 illustrates a non-limiting embodiment of one database schema 1000 of the database referred to 910 in FIG. 9. The database 1000 has several tables, some of which are described as follows. The Programs Table 1002 contains some of the subsidy business rules for a particular program or programs. For example, some non-limiting examples of said subsidy business rules might include whether the request for the subsidy billing codes is within the programs' start and stop date, whether the patient's age is within the permitted range for the programs, whether the program is active or dormant, whether the programs support the subsidization of companion target medications if the subject target medication is an anchor medication, whether the programs support the subsidization of generic target medications directly by the generic medications' manufacturers, and whether the requestor should be notified of any limits on subsidies offered with respect to the days supplies of subsidized medications. The Sponsored Meds table 1005 contains information about the medications who are directly subsidized when part of a medication synchronization or whose presence in a medication synchronization allows for the subsidization of companion medications. The Sponsored Meds table 1005 contains the BIN, Group and PCN values for the sponsored medications which will be used to populate the subsidy billing codes made available to the requestor for said medications. The Companion Meds table 1006 contains information about the medications which are indirectly subsidized when part of a medication synchronization in the presence of a sponsored medication in which the subsidy business rules for the program to which the sponsored medication belongs allows for the subsidization of a companion medication when the sponsored medication is an anchor medication or other rules as determined by the program sponsor. The Sponsored Meds table 1005 contains the NDC or National Drug Code, a commonly used identifier for medications, as well as other characteristics that may inform the program business rules including but not limited to whether the companion medication is a generic, whether it is a scheduled medication as determined by the Drug Enforcement Agency, and whether it is a Schedule 2 medication as determined by the Drug Enforcement Agency. If a companion medication is sponsored for a particular medication synchronization, its subsidy billing codes may use the BIN, Group and PCN values of the sponsored medication.

As also illustrated in FIG. 10, the Subsidy ID table 1004 contains an array of Subsidy es. Each program has its own Subsidy ID table. When a set of billing codes is being created for a subsidized medication, an unused value from the Subsidy ID table is copied to the Subsidized Medication Synchronization Notice table 1007, BIN, Group and PCN (if needed) values from the Sponsored Meds table 1005 and an NDC either from the Sponsored Meds table 1005 or the Companion Meds table 1006. The Sponsors table 1001 contains information about the sponsor of the subsidy while the Copay Subsidy Processors table 1003 contains information about the copay subsidy processor of the subsidy. Both tables 1001 and 1003 are used for activity reporting, auditing, billing and other purposes.

As also illustrated in FIG. 9, the service computer 901 may include or otherwise be in communication with a service application 903. The application module 903 may include business rules and instructions, perhaps stored in a database 910, for determining whether one or more subsidy billing code requests received from a pharmacy computer 915 should have subsidy billing codes made available. If the service application 903 determines that one or more subsidy billing code requests should be responded to by making subsidy billing codes available, said subsidy billing codes may be generated and made available via communications network 911 by (i) sending a message to the pharmacy computer 915, (ii) allowing them to be viewed via a web browser in the pharmacy computer 915. (iii) sending a facsimile to the requestor printed at a fax machine 914, and (iv) printing to a printer accessible by the requestor 913.

The application module 903 may be implemented as computer-implemented instructions of the memory 902 of the service computer 901. Alternatively, the application module 903 may also be implemented as computer-implemented instructions of a memory of a separate processor-based system that operates in tandem with the service computer 901, according to an example embodiment of the invention. It will be appreciated that while the service computer 901 has been illustrated as a single computer or processor, the service provider computer 901 may be comprised of a group of computers or processors, according to an example embodiment of the invention.

The communications network 911 may include any telecommunication and/or data network, whether public, private, or a combination thereof, including a local area network, a wide area network, an intranet, an internet, the Internet, intermediate hand-held data transfer devices, a publicly switched telephone network (PSTN), and/or any combination thereof and may be wired and/or wireless. The communications network 911 may also allow for real-time, off-line, and/or batch transactions to be transmitted between or among the service computer 901, and/or the copay subsidy processor computer 912 and/or the pharmacy management computer 915. Due to network connectivity, various methodologies as described herein may be practiced in the context of distributed computing environments. It will also be appreciated that the communications network 911 may include a plurality of networks, each with devices such as gateways and routers for providing connectivity between or among networks 911. Instead of or in addition to a network 911, dedicated communication links may be used to connect the various devices in accordance with an example embodiment of the invention. For example, the service computer 901 may form the basis of network 911 that interconnects the pharmacy management computer 915 and the copay subsidy processor computer 912.

Generally, each of the memories and data storage devices, such as the memory 902 and the database 910, and/or any other memory and data storage device, can store data and information for subsequent retrieval. In this manner, the system 900 can store various received or collected information in memory or in a database associated with one or more pharmacy management computers 915, copay subsidy processor computers 912, and/or service computers 901. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage device. In other embodiments, the databases shown can be integrated or distributed into any number of databases or other data storage devices. In one example embodiment, for security, the service computer 901 (or any other entity) may have a dedicated connection to the database 910, as shown; though, in other embodiments, the service computer 901 or another entity may communicate with the database 910 via a communications network 911.

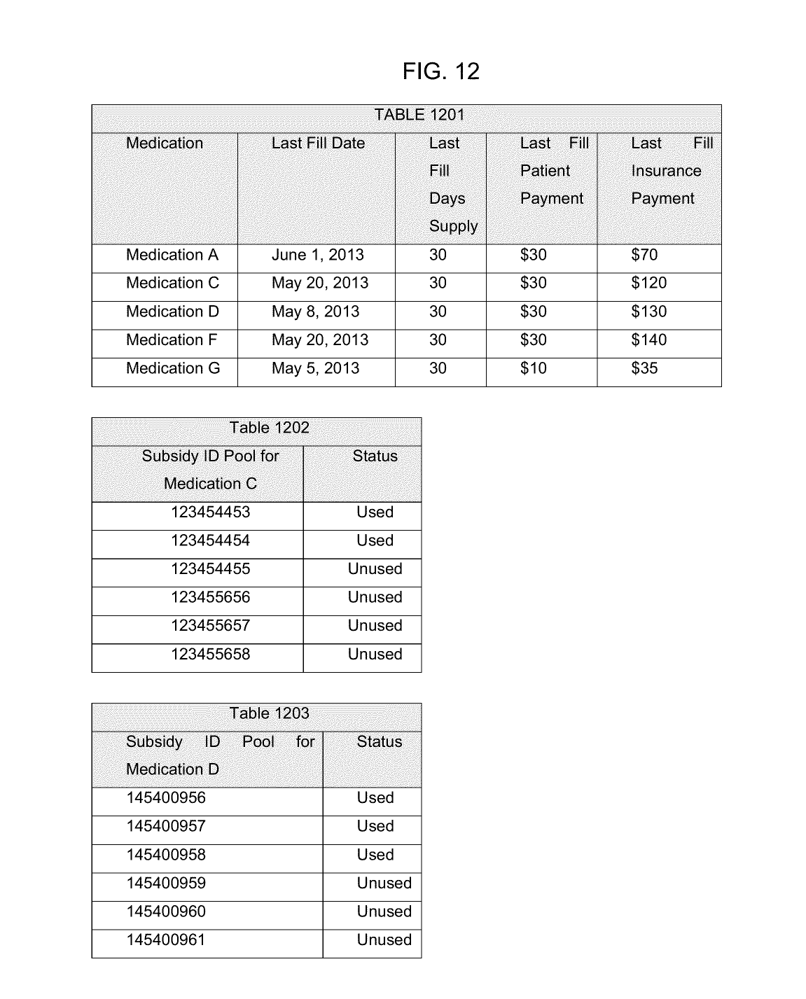

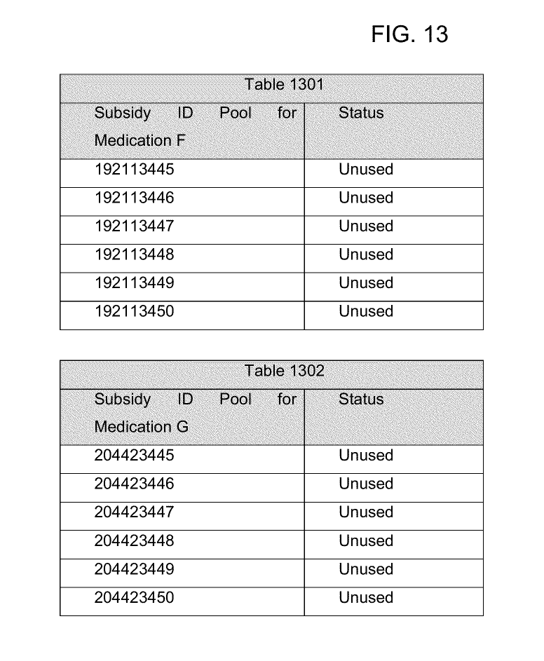

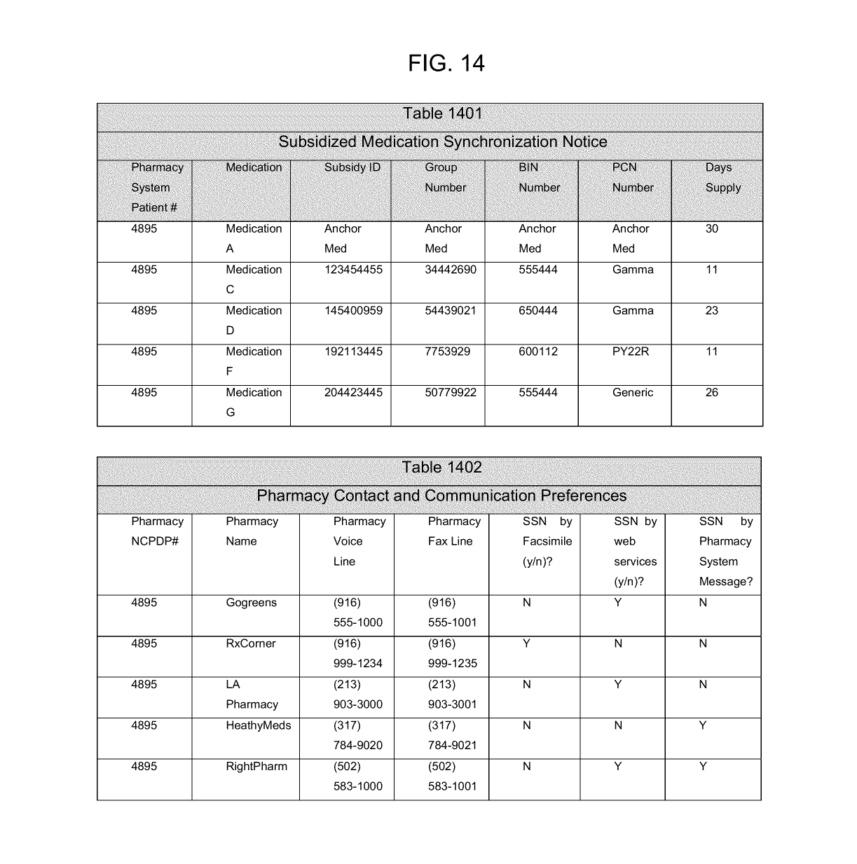

It is useful to note that the tables depicted in FIG. 11, FIG. 12, FIG. 13, and FIG. 14 are also non-limiting embodiments of tables that may exist in the one or more databases 910 to support the functions described herein.

Suitable processors, such as the processor 907 of the service computer 901, processor of the pharmacy management computer 915, and/or processor of the copay subsidy processor computer 912, respectively, may comprise a microprocessor, an ASIC, and/or a state machine. Example processors can be those provided by Intel Corporation (Santa Clara, Calif.), AMD Corporation (Sunnyvale, Calif.), and Motorola Corporation (Schaumburg, Ill.). Such processors comprise, or may be in communication with media, for example computer-readable media, which stores instructions that, when executed by the processor, cause the processor to perform the elements described herein. Embodiments of computer-readable media include, but are not limited to, an electronic, optical, magnetic, or other storage or transmission device capable of providing a processor with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript. Furthermore, any of the processors may operate any operating system capable of supporting locally executed applications, client-server based applications, and/or browser or browser-enabled applications.

FIG. 7 illustrates a non limiting example of how the pharmacy staff which requested the subsidy billing codes might proceed to user them to acquire subsidies for patient medication copayments for medications subject to a medication synchronization service. The pharmacy staff enters the subsidy billing codes into a pharmacy management computer 707 and submits a subsidy request 701 to a copay subsidy processor computer 703 via a claims clearing house 705 which uses the BIN values in the subsidy billing codes to route 702 the requests to the correct copay subsidy processor 703. The copay subsidy processor computer 703 which adjudicates the subsidy requests and sends responses 704 to the claims clearing house 705 which uses data within the subsidy response to route 706 the subsidy response to the correct pharmacy management computer 707,

The system 900 shown in and described with respect to FIG. 9 and the database schema shown in and described in FIG. 10 are provided by way of example only. Numerous other operating environments, system architectures, and device configurations are possible. Other system embodiments can include fewer or greater numbers of components and may incorporate some or all of the functionality described with respect to the system components shown in FIG. 9. As an example, in one example embodiment, the service computer 901 may be implemented as a specialized processing machine that includes hardware and/or software for performing the methods described herein. In addition, the processor and/or processing capabilities of the service computer 901 and/or the application 903, may be implemented as part of the pharmacy computer 915, the claims processor computer 912, or any combination or portion thereof. Accordingly, embodiments of the invention should not be construed as being limited to any particular operating environment, system architecture, or device configuration.

### Non Limiting Illustration of Some Embodiments of the Invention

The following is a non limiting illustration of some embodiments of the invention using a fictitious user of the invention, a fictitious patient, a fictitious pharmacy, fictitious medications and fictitious copay subsidy processors.

An organization using the invention, Bestscript, sets up contracts with copay subsidy processors in which the copay subsidy processors will facilitate the subsidization of part or all of a patient's prescription medication copay(s) in conjunction with a medication synchronization service. Each copay subsidy processor may have upstream agreements with program sponsors (for example, medication manufacturers or health plans) as the ultimate sources of subsidization.

By June of 2013, Bestscript has contracts with the copay subsidy processors representing certain medications as illustrated in Table 1101 in FIG. 11.

The BIN, PCN and Group numbers are conveyed to Bestscript by the copay subsidy processors. The sponsor for Medication A offers the patient a 50% subsidy of his copay when it is part of a medication synchronization service, but not an anchor med. The sponsors for all the other medications offer the patient 100% off his copay when they are part of a medication synchronization service, but not an anchor med.

For each of these sponsored medications, the copay subsidy processor conveys a pool of pre-approved Subsidy IDs to Bestscript.

Bestscript also contracts with a network of participating pharmacies. As part of the pharmacy contract, Bestscript makes available subsidy billing codes when appropriate. Among the pharmacies contracted with Bestscript is Gogreens Pharmacy.

On Jun. 1, 2013, patient Maxine Paye requests a refill of her prescription for Medication A from her local pharmacy, Gogreens, by calling the pharmacy and entering her prescription number for Medication A into the Gogreens touchtone refill by phone service.

Maxine's medication regimen is illustrated in Table 1201 in FIG. 12.

The pharmacy staff becomes aware that Maxine is a candidate for medication synchronization. This awareness may be caused by one or more factors including but not limited to (i) manual analysis of Maxine's regimen by the pharmacy staff, (ii) computerized analysis of Maxine's regimen or (iii) an alert system tied to either a paid insurance claim for a specific medication or (iv) a “ready for pickup” status in the pharmacy management system for a particular medication. The pharmacy staff contacts Maxine and sets an appointment for her to come into the pharmacy for a medication synchronization service.

The pharmacy staff uses a computer system with an interface to Bestscript that facilitates the submission to Bestscript of the identifiers of the target medications (the medications it wishes to synchronize) as part of a request for subsidy billing codes. In conjunction with a medication synchronization service, the pharmacy submits a subsidy billing code request to Bestscript.

Upon receipt of the request for subsidy billing codes, the invention then maps Table 1101 in FIG. 11 to Table 1201 in FIG. 12 to determine (i) which medications are eligible meds and (ii) applies any additional business rules to the adjudication process. Upon such adjudication, the invention determines that Medication A, Medication C, Medication D and Medication F are eligible meds outright and based upon the business rules, Medication G is an eligible med if Medication A is the anchor med.

Since Medication A, the current med, is an anchor med, subsidy billing codes will not be provided for Medication A. Maxine will pay the usual copayment of $30 for Medication A.

However, for the other medications in Table 2, the invention will source the subsidy billing codes for these meds from Table 1 and use them to populate a Subsidized Medication Synchronization Notice Table (Table 6). It will also pull the next available (unused) Subsidy ID from Tables 1202 and 1203 in FIG. 12 and Tables 1301 and 1302 respectively in FIG. 13 which represent pools of preapproved Subsidy IDs for Medications C, D, F and G respectively and insert them into Table 1401 in FIG. 14.

Once Table 1401 in FIG. 14 is populated in response to the processing of the subsidy billing code request, the invention is ready to create the Subsidized Medication Synchronization Notice. The invention refers to Table 1402 in FIG. 14, Pharmacy Communication Preferences, to reference how this Gogreen's Pharmacy prefers to receive the information contained within a Subsidized Medication Synchronization Notice. As we can see from Table 1402 in FIG. 14, Gogreens preferred to have the Subsidized Medication Synchronization Notice delivered by web services. The invention then generates a message which is delivered by web services to the Gogreens Pharmacy.

Next, the pharmacy staff prints the information received back from Bestscript and attaches it to Maxine's Medication A prescription which has been filled and is now awaiting Maxine's arrival at the pharmacy.

When Maxine arrives at the pharmacy for her med-sync appointment, the pharmacist on duty sees the notice attached to her Medication A prescription in will call and explains to Maxine that she can have four of her other medications synchronized with no out of pocket cost to her.

Maxine accepts the offer and is told that her other medication will be ready to go in about 15 minutes. The pharmacy staff submits subsidy requests for the four eligible meds using the subsidy billing codes on the Subsidized Synchronization Notice. After receiving approval responses to the subsidy requests from the copay subsidy processor(s), the prescriptions are filled and Maxine's copay for each of the four eligible meds is $0 since they were sponsored at a 100% subsidy.

The pharmacy staff person explains to Maxine that her total cost for the five prescriptions (one anchor med and four eligible meds) is $30 which represents her normal copay cost for Medication A of $30 and $0 copay for the other meds. Maxine is also told that going forward, all five of her medications will have the same refill date and that all her meds are next due to be refilled in 30 days, or Jul. 1, 2013.

Maxine purchases the five medications. The subsidized medication synchronization is now complete.

### Non Limiting Illustration of Some Embodiments of the Process Flow of the Invention

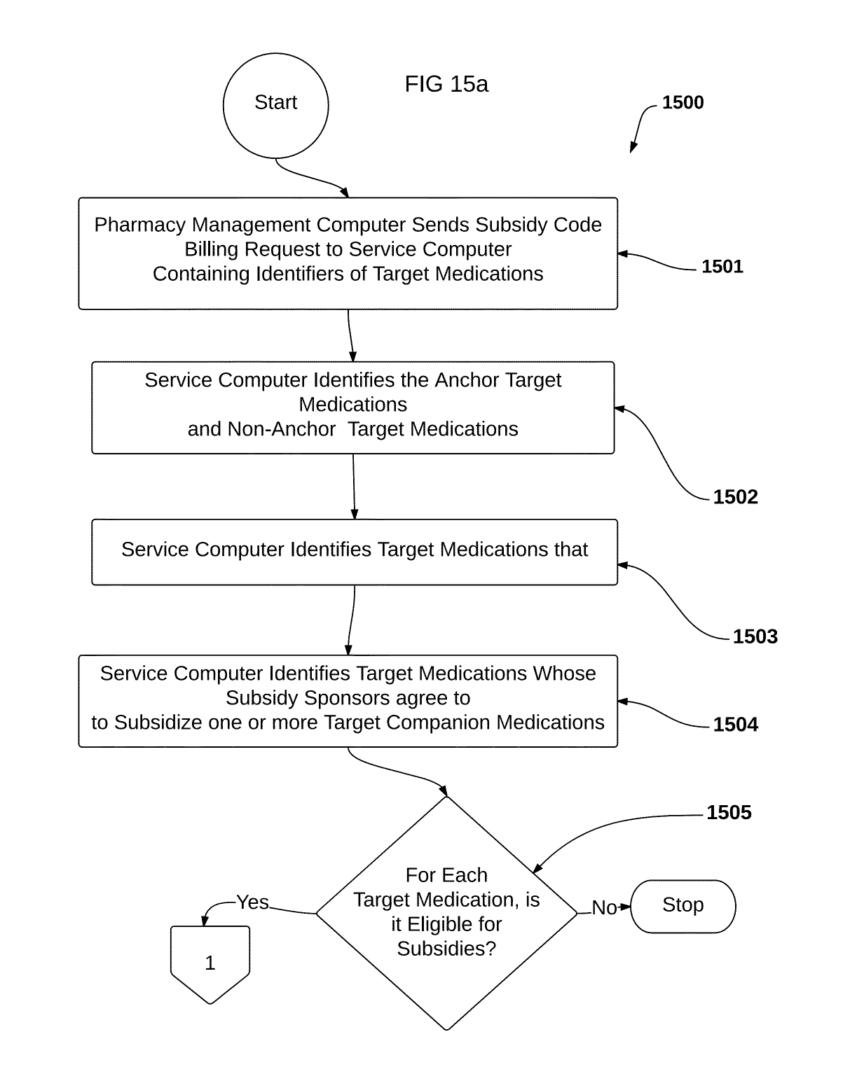

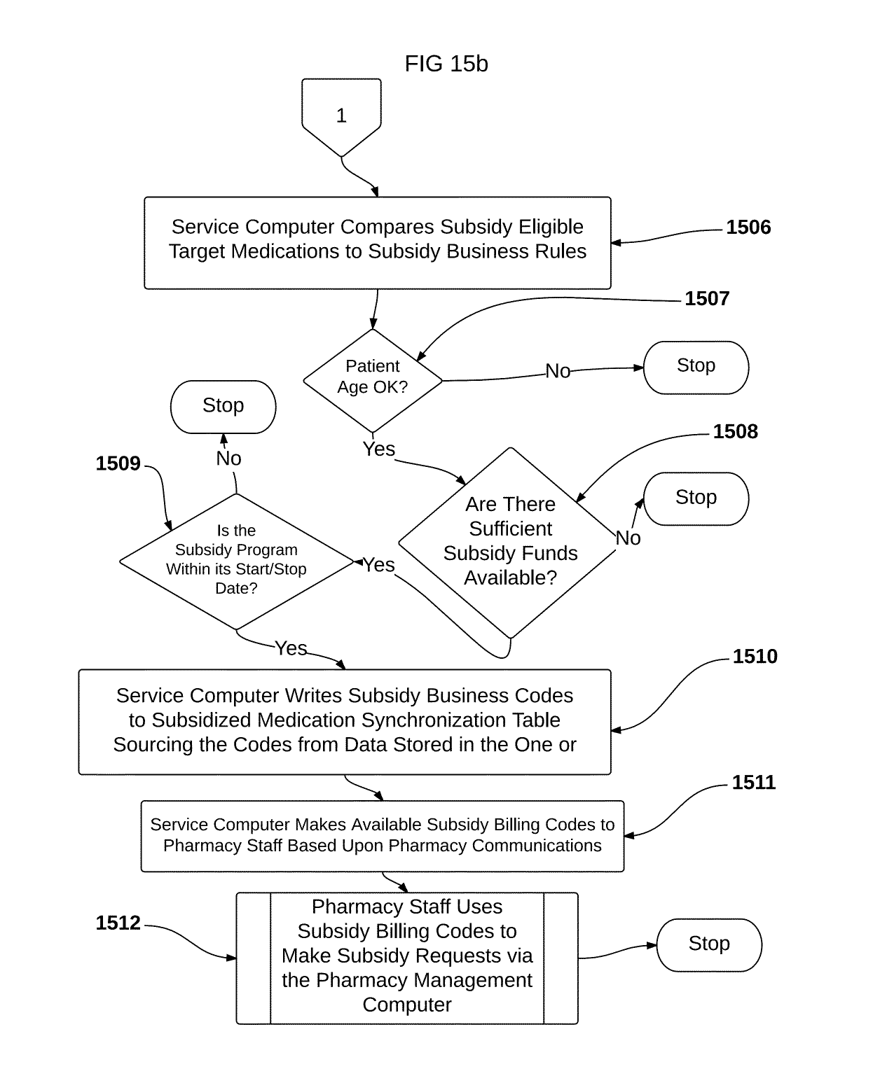

FIGS. 15a and 15b depict a non limiting example of a process flow 1500 for supporting financial subsidization of patient out of pocket costs for prescription medications in conjunction with a medication synchronization service.

The pharmacy computer sends 1501 a subsidy billing code request to the service computer. The service computer examines the information in the subsidy billing code request, including the medication identifiers of the target medications, and determines which of the target medications are 1502 anchor medications, direct subsidy eligible 1503 medications, and indirect subsidy eligible (or “companion”) 1504 medications. Based on this logic, the service computer may determine 1505 which of the target medications are eligible for subsidies, subject to subsidy business rules. For target medications that are eligible for subsidies, subject to subsidy business rules, the service computer next applies 1506 the subsidy business rules. Subsidy business rules may include (i) the patient's age must be within a certain range 1507, and/or (ii) the subsidy program must have remaining funds available 1508 and/or (iii) the subsidy buffing code request must have been made with a certain date range 1509. For subsidy eligible medications that survive the application of the subsidy business rules, subsidy billing codes are written 1510 to a Subsidy Medication Synchronization Table where they are made available 1511 to pharmacy staff in accordance with pharmacy communications preferences. Once pharmacy staff has received the subsidy billing codes, they may use them to submit requests 1512 for subsidies of said surviving subsidy eligible medications as is illustrated in FIG. 7.

### Non Limiting Summary of a Preferred Embodiment

In preferred embodiments, the present invention comprises a computer implemented method, system and a nontransitory, computer-readable storage medium storing computer-executable instructions for mapping information derived from a patients' drug regimen to a set of information derived from a set of one or more copay subsidy processor entities and applying a set of program business rules to create a set of subsidy billing codes that facilitate financial subsidizations for patients participating in a process of prescription medication synchronization service, said method comprising:

creating a set of one or more databases containing subsidy eligible medication identifiers, subsidy billing codes and subsidy business rules;

mapping said subsidy billing codes to said subsidy eligible medications in said set of one or more databases, said subsidy billing codes to include at least the following fields: (1) Bank Identification Number or BIN, (2) Subsidy ID;

receiving a request for said subsidy billing codes for one or more target medications in conjunction with a medication synchronization service;

comparing said one or more target medication identifiers in said request for said subsidy billing codes with said subsidy eligible medication identifiers and said subsidy business rules; and

responding to said request for said subsidy billing codes by making available to requester one or more sets of subsidy billing codes corresponding to said one or more target medications, subject to one or more target medications being subsidy eligible medications and further subject to said subsidy business rules.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A computer implemented method for mapping information derived from patients' medication regimens to a set of information derived from a set of one or more copay subsidy processor entities to create a set of subsidy billing codes that facilitate financial subsidizations for patients participating in a prescription medication synchronization service, said method comprising:
creating a set of one or more databases containing subsidy eligible medication identifiers, subsidy billing code fields and subsidy business rules;
mapping said subsidy billing code fields to said subsidy eligible medications in said set of one or more databases, said subsidy billing code fields to include at least the following fields: (1) Bank Identification Number or BIN, (2) Subsidy ID;
receiving a request for subsidy billing codes for one or more target medications in conjunction with a medication synchronization service;
comparing said one or more target medication identifiers in said request for said subsidy billing codes with said subsidy eligible medication identifiers and said subsidy business rules; and
responding to said request for said subsidy billing codes by making available to requester one or more sets of subsidy billing codes corresponding to said one or more target medications, subject to one or more target medications being said subsidy eligible medications and further subject to said subsidy business rules.

2. The method of claim 1, further comprising a set of subsidy billing codes that are comprised with a Group field.

3. The method of claim 1, further comprising receiving a request from a pharmacy or pharmacy staff person or pharmacy computer system for said subsidy billing codes for one or more target medications in conjunction with a medication synchronization service.

4. The method of claim 1, further comprising sending a response to said requester containing one or more sets of said subsidy billing codes corresponding to one or more said target medications, subject to one or more target medications being subsidy eligible medications and further subject to said subsidy business rules.

5. The method of claim 4, further comprising sending said response to said requester via facsimile, SMS, email, file transfer protocol or web services.

6. The method of claim 1, further comprising making available said subsidy billing codes though an encrypted medium.

7. The method of claim 1, further comprising making available previously generated subsidy billing codes to said requester based upon a transaction identifier field submitted by said requester.

8. The method of claim 1, further comprising subsidy business rules that use characteristics of the patient's prescription insurance benefit as an input.

9. The method of claim 1, further comprising subsidy business that use the presence of one or more target medications in a request for subsidy billing codes request as an input for the subsidy business rules for one or more other target medications.

10. The method of claim 1, further comprising subsidy business rules that use information from a paid insurance claim for a target medication as an input.

11. A nontransitory, computer-readable tangible storage medium storing computer-executable instructions executed on a processor that allows information derived from patients' medication regimens to be mapped a set of information derived from a set of one or more copay subsidy processor entities to create a set of subsidy billing codes that facilitate financial subsidizations for patients participating in a prescription medication synchronization service, said instructions comprising:
Instructions to read information from a set of one or more databases containing subsidy eligible medication identifiers, subsidy billing code fields and subsidy business rules;
Instructions that map said subsidy billing code fields to said subsidy eligible medications in said set of one or more databases, said subsidy billing code fields to include at least the following fields: (1) Bank Identification Number or BIN, (2) Subsidy ID;
Instructions to receive a request for said subsidy billing codes for one or more target medications in conjunction with a medication synchronization service;
Instructions to compare said one or more target medication identifiers in said request for said subsidy billing codes with said subsidy eligible medication identifiers and said subsidy business rules; and
Instructions to respond to said request for said subsidy billing codes by making available to requester one or more sets of subsidy billing codes corresponding to said one or more target medications, subject to one or more target medications being said subsidy eligible medications and further subject to said subsidy business rules.

12. The computer-readable storage medium of claim 11, wherein said instructions further comprise an instruction to receive a request from a pharmacy or pharmacy staff person or pharmacy computer system for said subsidy billing codes for one or more target medications in conjunction with a medication synchronization service.

13. The computer-readable storage medium of claim 11, wherein said instructions further comprise an instruction to send a response to said requester containing one or more sets of said subsidy billing codes corresponding to one or more said target medications, subject to one or more target medications being subsidy eligible medications and further subject to said subsidy business rules.

14. The computer-readable storage medium of claim 13, wherein said instructions further comprise an instruction to send said response to said requester via facsimile, SMS, email, file transfer protocol or web services.

15. The computer-readable storage medium of claim 11, wherein said instructions further comprise an instruction to make available said subsidy billing codes though an encrypted medium.

16. The computer-readable storage medium of claim 11, wherein said instructions further comprise an instruction to make available previously generated subsidy billing codes to said requester based upon a transaction identifier submitted by said requester.

17. The computer-readable storage medium of claim 11, wherein said instructions further comprise an instruction to receive characteristics of the patient's prescription insurance benefit as an input to applying said subsidy business rules.

18. The computer-readable storage medium of claim 11, wherein said instructions further comprise an instruction to use the presence of one or more target medications in a request for subsidy billing codes request as an input for the subsidy business rules for one or more other target medications.

19. The computer-readable storage medium of claim 11, wherein said instructions further comprise an instruction to comprise subsidy billing codes with a Group field.

20. The computer-readable storage medium of claim 11, wherein said instructions further comprise subsidy business rules that use information from a paid insurance claim for a target medication as an input.

21. A system for mapping information derived from patients' medication regimens to a set of information derived from a set of one or more copay subsidy processor entities to create a set of subsidy billing codes that facilitate financial subsidizations for patients participating in a prescription medication synchronization service, said system comprising:
a communication network;
one or more computers coupled to the communications network, each computer having one or more processors, and memory coupled to the one or more processors;
one or more databases coupled to said one or more computers;
one or more computers having an application stored thereon, the application configured or programmed to receive inputs at the processor derived from a copay subsidy processor including subsidy eligible medication identifiers, subsidy billing code fields and subsidy business rules wherein the application is programmed to map said subsidy billing code fields to said subsidy eligible medications in said set of one or more databases, said subsidy billing codes to include at least the following fields: (1) Bank Identification Number or BIN, (2) Subsidy ID;
wherein the application is configured or programmed to cause the processor upon receipt of a request for subsidy billing codes for target medications to compare said one or more target medication identifiers in said request for said subsidy billing codes with said subsidy eligible medication identifiers and said subsidy business rules;
wherein the application is configured or programmed to cause the processor to respond to said request for said subsidy billing codes made to one or more computers connected to said communications network by making available to requester via said communications network, one or more sets of subsidy billing codes corresponding to said one or more target medications, subject to one or more target medications being subsidy eligible medications and further subject to said subsidy business rules.

22. The system of claim 21 wherein the application is configured or programmed to send a response to said requester containing one or more sets of said subsidy billing codes corresponding to said target medications, subject to one or more target medications being subsidy eligible medications and further subject to said subsidy business rules.

23. The system of claim 22 wherein the application is configured or programmed to send a response to said requester via facsimile, SMS, email, file transfer protocol or web services

24. The system of claim 21, wherein the application is configured or programmed to make available said subsidy billing codes though an encrypted medium.

25. The system of claim 21, wherein the application is further configured or programmed to make available previously generated subsidy billing codes to said requester based upon a transaction identifier submitted by said requester

26. The system of claim 21, wherein the application is configured or programmed to further include subsidy business rules that use characteristics of the patient's prescription insurance benefit as an input.

27. The system of claim 21, wherein the application is further configured or programmed to use the presence of one or more target medications in a request for subsidy billing codes request as an input for the subsidy business rules for one or more other target medications.

28. The system of claim 21 wherein the application is configured or programmed to further comprise subsidy billing codes that are comprised with a Group field.

29. The system of claim 21 wherein the application is configured or programmed to receive a request from a pharmacy or pharmacy staff person or pharmacy computer system for said subsidy billing codes for one or more target medications in conjunction with a medication synchronization service.

30. The system of claim 21, wherein the application is further configured or programmed such that the subsidy business rules use information from a paid insurance claim for a target medication as an input.
